(19) United States
(12) Patent Application Publication
(10) Pub. No.: US 2026/0216653 A1
(43) Pub. Date: Jul. 30, 2026

(54) METHODS FOR MAKING CHARGED ULTRAFILTRATION MEMBRANES AND USES THEREOF IN DAIRY APPLICATIONS

(71) Applicants: Allison Marie MERZ, O'Fallon, MO (US); lan James BROWN, Brentwood, TN (US); FAIRLIFE, LLC, Chicago, IL (US); The Board of Trustees of The University of Alabama, Tuscaloosa, AL (US)

(72) Inventors: Allison Marie MERZ, O'Fallon, MO (US); lan James BROWN, Brentwood, TN (US); Stephen Michael Christopher RITCHIE, Northport, AL (US); Shakeel UR REHMAN, Naperville, IL (US)

(73) Assignees: fairlife, LLC, Chicago, IL (US); The Board of Trustees of The University of Alabama, Tuscaloosa, AL (US)

(21) Appl. No.: 19/146,978

(22) PCT Filed: Jan. 11, 2024
(86) PCT No.: PCT/US2024/011262

§ 371 Date: Jul. 10, 2025

Related U.S. Application Data
(60) Provisional application No. 63/479,560, filed on Jan. 12, 2023.

(51) Int. Cl. B01D 61/14; B01D 67/00; B01D 69/10; B01D 71/68

(52) U.S. Cl. CPC B01D 61/145; B01D 67/0006; B01D 69/106; B01D 71/68; B01D 2323/081; B01D 2323/219; B01D 2323/30; B01D 2323/345

(57) ABSTRACT

Charged ultrafiltration membranes are synthesized by thermally initiated free-radical polymerization and grafting of sodium styrene sulfonate in the pores of an ultrafiltration precursor membrane. The resulting grafted chains of the charged UF membrane provide significant negative charge to maintain nearly complete rejection of proteins at significantly higher flux.

### REFERENCE TO RELATED APPLICATION

This application is being filed on Jan. 11, 2024, as a PCT International Patent Application and claims the benefit of and priority to U.S. Provisional Patent Application No. 63/479,560, filed on Jan. 12, 2023, the disclosure of which is incorporated herein by reference in its entirety.

### BACKGROUND OF THE INVENTION

The present invention relates generally to the use of ultrafiltration membranes for fractionating aqueous streams containing protein, sugar, and minerals. The protein is retained by the membrane, while sugar, minerals, and water permeate through the membrane.

### SUMMARY OF THE INVENTION

This summary is provided to introduce a selection of concepts in a simplified form that are further described herein. This summary is not intended to identify required or essential features of the claimed subject matter. Nor is this summary intended to be used to limit the scope of the claimed subject matter.

Consistent with aspects of this invention, a method for making an ultrafiltration membrane is disclosed herein, and this method can comprise (a) contacting a pre-cursor membrane comprising a polyethersulfone (PES) and/or a polysulfone (PSF) with an aqueous mixture comprising sodium styrene sulfonate, a free radical initiator, a crosslinking agent, and water, and (b) curing the pre-cursor membrane to form the ultrafiltration membrane, wherein the ultrafiltration membrane has sulfonated polystyrene covalently bound in pores and/or covalently bound on an external surface of the ultrafiltration membrane. Optionally, the aqueous mixture can further contain a co-solvent (e.g., methanol, n-butanol, and the like) and/or a pore wetting agent (e.g., glycerin).

Ultrafiltration membranes also are encompassed herein. Generally, the ultrafiltration membranes can comprise (I) a polyethersulfone (PES) and/or a polysulfone (PSF) membrane, and (II) sulfonated polystyrene covalently bound in pores and/or covalent bound on an external surface of the ultrafiltration membrane. More often, the ultrafiltration membrane further includes a mechanical support layer positioned underneath (and attached to) the membrane. The mechanical support layer can comprise a polypropylene (PP) or a polyester (PET), such as a non-woven PP or PET.

In accordance with other aspects of this invention, ultrafiltration modules and milk fractionation systems are provided herein. A representative ultrafiltration module can comprise (1) an inlet for a feed stream (e.g., a dairy product such as whole or skim milk), (2) one or more of any of the ultrafiltration membranes disclosed herein in any suitable configuration, such as a hollow fiber configuration, a tubular configuration, or a spiral wound configuration, (3) a first outlet for a UF retentate stream, and (4) a second outlet for a UF permeate stream. A representative milk fractionation system can comprise (A) one or more than one of any of the ultrafiltration modules disclosed herein, (B) a nanofiltration module, and (C) a reverse osmosis module.

Methods for making a dairy composition also are encompassed herein. One such method can comprise (i) ultrafiltering a milk product using any of the ultrafiltration membranes disclosed herein (or any of the ultrafiltration modules disclosed herein) to produce a UF permeate fraction and a UF retentate fraction, (ii) nanofiltering the UF permeate fraction to produce a NF permeate fraction and a NF retentate fraction, (iii) subjecting the NF permeate fraction to a reverse osmosis step to produce a RO permeate fraction and a RO retentate fraction, and (iv) combining at least two of the UF retentate fraction, the RO permeate fraction, the RO retentate fraction, and a fat-rich fraction to form the dairy composition.

Both the foregoing summary and the following detailed description provide examples and are explanatory only. Accordingly, the foregoing summary and the following detailed description should not be considered to be restrictive. Further, features or variations can be provided in addition to those set forth herein. For example, certain aspects can be directed to various feature combinations and sub-combinations described in the detailed description.

### BRIEF DESCRIPTION OF THE FIGURES

The following figures form part of the present specification and are included to further demonstrate certain aspects of the present invention. The invention may be better understood by reference to these figures in combination with the detailed description and examples.

FIG. 1 is a scanning electron microscope (SEM) photograph of a pre-cursor membrane containing a top layer of PSF and a bottom mechanical support layer.

FIG. 2 presents an illustration of covalently bonded polystyrene in the pores of the ultrafiltration membrane.

FIG. 3 presents a representative schematic diagram of diffusion of the aqueous mixture or solution into the pores of the pre-cursor membrane prior to curing.

FIG. 4 presents a bar chart of water permeability for the pre-cursor membranes of Comparative Examples 5-6 and the charged ultrafiltration membranes of Examples 4A-4B.

FIG. 5 is a plot of absorbance versus milk concentration at a wavelength of 280 nm.

FIG. 6 presents a bar chart of skim milk process flux for the pre-cursor membranes of Comparative Examples 5-6 and the charged ultrafiltration membranes of Examples 3A and 4A.

FIG. 7 presents a bar chart of skim milk permeability for the pre-cursor membranes of Comparative Examples 5-6 and the charged ultrafiltration membranes of Examples 3A and 4A.

FIG. 8 present a bar chart of protein rejection for the pre-cursor membranes of Comparative Examples 5-6 and the charged ultrafiltration membranes of Examples 3A-3B and 4A.

FIG. 9 presents a bar chart of skim milk process flux for the pre-cursor membrane of Comparative Example 5 and the charged ultrafiltration membranes of Examples 3A-3B.

FIG. 10 presents a bar chart of skim milk permeability for the pre-cursor membrane of Comparative Example 5 and the charged ultrafiltration membranes of Examples 3A-3B.

FIG. 11 present a bar chart of protein rejection for the pre-cursor membranes of Comparative Examples 5-6 and the charged ultrafiltration membranes of Examples 3A-3B.

FIG. 12 is a plot of absorbance versus wavenumber (cm⁻¹) for the pre-cursor membrane of Comparative Example 6 before and after the CIP cleaning procedure.

FIG. 13 is a plot of absorbance versus wavenumber (cm⁻¹) for the ultrafiltration membrane of Example 2A before and after the CIP cleaning procedure.

FIG. 14 is a plot of absorbance versus wavenumber (cm⁻¹) for the ultrafiltration membrane of Example 7 before and after the CIP cleaning procedure.

FIG. 15 is a plot of absorbance versus wavenumber (cm⁻¹) for the ultrafiltration membrane of Example 8 before and after the CIP cleaning procedure.

FIG. 16 presents a bar chart of integrated area under the ATR-FTIR curves of FIGS. 13-15 for the ultrafiltration membranes described in Examples 2A and 7-8 before and after the CIP cleaning procedure.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), can be applied, as long as that definition does not conflict with any other disclosure or definition applied herein, or render indefinite or non-enabled any claim to which that definition can be applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and/or feature disclosed herein, all combinations that do not detrimentally affect the systems, compositions, processes, and/or methods described herein are contemplated with or without explicit description of the particular combination. Additionally, unless explicitly recited otherwise, any aspect and/or feature disclosed herein can be combined to describe inventive systems, compositions, processes, and/or methods consistent with the present invention.

In this disclosure, while compositions and methods and systems are often described in terms of “comprising” various materials or steps or components, the compositions and methods and systems also can “consist essentially of” or “consist of” the various materials or steps or components, unless stated otherwise.

The terms “a,” “an,” and “the” are intended to include plural alternatives, e.g., at least one, unless otherwise specified. For instance, the disclosure of “an ultrafiltration membrane” is meant to encompass one or more than one ultrafiltration membrane, unless otherwise specified.

In the disclosed methods, the terms “combining” and “contacting” encompass the combining or contacting of materials in any order, in any manner, and for any length of time, unless otherwise specified. For example, the materials can be blended, mixed, treated, impregnated, submerged, soaked, dipped, and the like.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. For example, the aqueous mixture in step (a) can contain from 1 to 60 wt. % sodium styrene sulfonate in aspects of this invention. By a disclosure that the aqueous mixture contains from 1 to 60 wt. % sodium styrene sulfonate, the intent is to recite that the weight percent can be any amount in the range and, for example, can include any range or combination of ranges from 1 to 60 wt. %, such as from 2 to 45 wt. %, from 3 to 25 wt. %, from 5 to 25 wt. %, from 7 to 23 wt. %, or from 10 to 30 wt. % sodium styrene sulfonate, and so forth. Likewise, all other ranges disclosed herein should be interpreted in a manner similar to this example.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

Although any methods, devices, and materials similar or equivalent to those described herein can be used in the practice or testing of the invention, the typical methods, devices, and materials are herein described.

All publications and patents mentioned herein are incorporated herein by reference in their entirety for the purpose of describing and disclosing, for example, the constructs and methodologies that are described in the publications and patents, which might be used in connection with the presently described invention.

### DETAILED DESCRIPTION OF THE INVENTION

Disclosed herein are ultrafiltration membranes that comprise a polyethersulfone (PES) and/or a polysulfone (PSF) membrane, and sulfonated polystyrene covalently bound in pores and/or covalently bound on an external surface of the ultrafiltration membranes; methods for producing the ultrafiltration membranes; ultrafiltration modules containing a plurality of the ultrafiltration membranes; milk fractionation systems containing a plurality of the ultrafiltration modules; and methods for making dairy compositions utilizing the ultrafiltration membranes and the ultrafiltration modules.

Ultrafiltration (UF) membranes are typically described by their molecular weight cut-off (MWCO, the molecular weight or size of the molecule that is retained by the membrane). For instance, for separating and concentrating proteins in the dairy industry, the MWCO for an ultrafiltration membrane can be 10 kDa, such that at least 90% of materials having molecular weights greater than 10,000 Daltons are retained (retentate), while lower molecular weight species pass through (permeate).

An objective of this invention is to produce an ultrafiltration membrane that maintains a high level of protein rejection, but does so at higher overall flux. Thus, the membrane would retain the same amount of protein at a higher throughput. For instance, the charged ultrafiltration membrane disclosed herein can retain protein at the same level as a standard 10 kDa MWCO ultrafiltration membrane, but with substantially higher flux (e.g., from 10 to 50% higher). This is accomplished by modifying a pre-cursor PES or PSF membrane with covalently bonded sulfonated polystyrene functional groups to form a charged polymer membrane, which rejects protein based both on molecular size and charge.

This objective is directed primarily to dairy applications, such as milk-based beverages and related products, due a large constituent being protein. However, the methods, techniques, membranes, and so forth that are described herein are not limited solely to milk or dairy applications, and can be applied also to non-alcoholic and alcoholic beverages generally including, but not limited to beer, wine, water, waste-water processing, juice, oat, almond/nut, pea, rice, seeds, grains and other plant material processing, and to end-use applications and products based on these materials. Another objective of this invention is to form the charged polymeric membrane using a free-radical polymerization process, instead of a cationic polymerization process that yields an ionic bond between polymer chains and the pre-cursor membrane. While any curing method can be used, in certain aspects, a thermal initiator is used for thermal curing of the free-radical polymerization process, thereby forming the charged UF membrane.

Yet another objective of this invention is to form the charged polymeric membrane in a straightforward synthesis scheme with a limited number of process steps, and in this case, via the use of sodium styrene sulfonate directly. Moreover, glycerin can be included in the aqueous mixture or solution, along with sodium styrene sulfonate, to promote and maintain wetting of the substrate membrane and pores.

While this invention is described in detail in relation to ultrafiltration (UF) membranes and methods of their manufacture, the methods and techniques disclosed herein also are applicable to microfiltration (MF) membranes, as well as to nanofiltration (NF) and reverse osmosis (RO) and forward osmosis (FO) membranes, and accordingly, MF membranes—and NF and RO and FO membranes—with covalently bound sulfonated polystyrene moieties are encompassed herein.

In addition to the food processing applications noted above, other non-limiting uses for charged membranes (e.g., charged UF membranes, charged MF membranes) can include bacterial removal, virus removal, fermentation processes, ion exchange, isolation of rare elements, and isolation of charged paint particles, among other end-use applications.

### Ultrafiltration Membranes

Various methods for making ultrafiltration membranes are provided herein. For instance, a method of making an ultrafiltration membrane can comprise (or consist essentially of, or consist of) (a) contacting a pre-cursor membrane comprising a polyethersulfone (PES) and/or a polysulfone (PSF) with an aqueous mixture comprising sodium styrene sulfonate, a free radical initiator, a crosslinking agent, and water, and (b) curing the pre-cursor membrane to form the ultrafiltration membrane, wherein the ultrafiltration membrane has sulfonated polystyrene covalently bound in pores and/or covalently bound on an external surface of the ultrafiltration membrane.

Generally, the features of any of the methods disclosed herein (e.g., the PES polymer, the PSF polymer, the composition of the aqueous mixture, the curing process, and the temperature and time conditions under which any steps are performed, among others) are independently described herein, and these features can be combined in any combination to further describe the disclosed methods. Moreover, other process steps can be conducted before, during, and/or after any of the steps listed in the disclosed methods, unless stated otherwise. Additionally, any ultrafiltration membranes produced in accordance with any of the disclosed methods are within the scope of this disclosure and are encompassed herein.

Referring now to step (a), any suitable pre-cursor membrane that comprises a polyethersulfone (PES) polymeric material and/or a polysulfone (PSF) polymeric material can be utilized. Generally, the pre-cursor PES and PSF membranes have a pure water permeability that is at least 20% greater than a standard 10 kDa MWCO PES membrane, a non-limiting example of which is a 20 kDa MWCO PES membrane. The pre-cursor membrane can be fully wet, partially dry, or fully dry, and with or without glycerin prior to contact with the aqueous mixture in step (a). The pre-cursor membrane can be unsupported or supported, and when supported, typically on a PP or PET non-woven material.

The aqueous mixture in step (a) contains a monomer, typically sodium styrene sulfonate, and a free radical initiator, a crosslinking agent, and water. While not limited thereto, the aqueous mixture often contains from 1 to 60 wt. % sodium styrene sulfonate in one aspect, from 2 to 45 wt. % sodium styrene sulfonate in another aspect, from 3 to 25 wt. % sodium styrene sulfonate in another aspect, from 5 to 25 wt. % sodium styrene sulfonate in another aspect, from 7 to 23 wt. % sodium styrene sulfonate in yet another aspect, and from 10 to 30 wt. % sodium styrene sulfonate in still another aspect. The amount of sodium styrene sulfonate present in the aqueous mixture in step (a) often can be limited by the desired amount of diffusion into the pores or the desired extent of the reaction. For example, too much grafted polymer may form, thereby resulting in too much flux loss.

Likewise, the amount of the free radical initiator in the aqueous mixture is not particularly limited. Typical ranges include, but are not limited to, from 0.1 to 5 wt. %, from 0.1 to 1.5 wt. %, from 0.2 to 3 wt. %, from 0.2 to 1.5 wt. %, or from 0.2 to 1 wt. % of the free radical initiator, based on the weight of the aqueous mixture. The amount of the free radical initiator often can depend upon the amount of sodium styrene sulfonate present in the mixture or solution, the type of curing used in step (b), and the prevailing temperature, among other considerations.

Any suitable free radical initiator can be used in the aqueous mixture, but the type of initiator can depend upon the type of curing used in step (b). For thermal curing, a representative and non-limiting example of a suitable curing agent is potassium persulfate, which beneficially is both thermally activated and water soluble. Other suitable alternatives include sodium persulfate and ammonium persulfate, which are both water soluble. Non-water soluble initiators, such as azobisisobutyronitrile (AIBN), also can be used, but generally with a suitable co-solvent, typically a water soluble alcohol.

The amount of the crosslinking agent in the aqueous mixture in step (a) is not particularly limited. Typical ranges include, but are not limited to, from 0.1 to 8 wt. %, from 0.2 to 6 wt. %, from 0.3 to 4 wt. %, from 0.4 to 3 wt. %, or from 0.5 to 2 wt. % of the crosslinking agent, based on the weight of the aqueous mixture. Any suitable crosslinking agent can be used, and illustrative and non-limiting examples can include divinyl acetylene, divinyl sulfone, 5-hexadiene, divinylbenzene, substituted divinylbenzenes, and the like, as well as combinations thereof.

The initial combination of components in step (a) is described as a mixture, although often prior to polymer formation or with low concentrations of the components (monomer, initiator, crosslinker), it is a solution, e.g., a single phase solution. In such circumstances, the aqueous mixture in step (a) can further include a co-solvent to increase the solubility of the sodium styrene sulfonate, the crosslinking agent, and/or the free radical initiator in the aqueous mixture (or solution, if desired). Representative non-limiting examples of suitable co-solvents include methanol, n-butanol, and the like (e.g., other water soluble alcohols), as well as combinations thereof. Any suitable amount of co-solvent(s) can be used.

Optionally, the aqueous mixture (or solution) can further comprise a pore wetting agent, such as glycerin. While not wishing to be bound by theory, it can be advantageous in order to improve pore wetting and to prevent pores from drying out (or closing or collapsing) to have a small amount of a pore wetting agent (e.g., glycerin) present in the aqueous mixture, generally from as little as 0.1 wt. % ranging up to and including 25 wt. %. More often, the aqueous mixture contains from 0.5 to 20 wt. %, from 1 to 15 wt. %, from 2 to 8 wt. %, from 5 to 25 wt. %, or from 10 to 20 wt. % of the pore wetting agent (e.g., glycerin). Other suitable pore wetting agents can be used, such as polyols, a non-limiting example of which is propylene glycol.

In addition to the sodium styrene sulfonate, free radical initiator, crosslinking agent, optional co-solvent, and optional pore wetting agent, the aqueous mixture (or solution) in step (a) contains water, often as the majority component. While not limited thereto, the aqueous mixture (or solution) contains from 20 to 80 wt. % water, such as from 30 to 70 wt. %, from 30 to 45 wt. %, from 35 to 50 wt. %, or from 40 to 65 wt. % water.

Step (a) can be performed at any suitable temperature, such as from 10° C. to 90° C., from 20° C. to 70° C., from 15° C. to 55° C., from 20° C. to 45° C., or from 20° C. to 30° C., although not limited thereto. In these and other aspects, these temperature ranges also are meant to encompass circumstances where step (a) is conducted at a series of different temperatures, instead of at a single fixed temperature, wherein at least one temperature falls within the respective ranges. While not a requirement, often the temperature for step (a) is a lower temperature to prevent premature reaction of the sodium styrene sulfonate, free radical initiator, and crosslinking agent, and therefore, to prevent premature polymer formation prior to step (b).

The pressure at which step (a) is conducted is not particularly limited, but can be at an elevated pressure (e.g., from 5 psig to 100 psig), at atmospheric pressure, or at any suitable sub-atmospheric pressure. In some instances, step (a) is conducted at atmospheric pressure, eliminating the need for pressurized vessels and their associated cost and complexity. Step (a) can be performed for any time period sufficient for the aqueous mixture (or solution) to diffuse and/or wick into the pores of the pre-cursor membrane. Illustrative and non-limiting time periods include a wide range of time periods, such as from 2 sec to 6 hr, from 2 sec to 2 min, from 10 sec to 6 hr, from 10 sec to 2 min, from 15 sec to 5 hr, from 30 sec to 2 hr, from 1 min to 24 hr, from 1 min to 1 hr, from 5 min to 6 hr, from 15 min to 5 hr, or from 30 min to 2 hr, but is not limited solely to these time periods. Other appropriate temperature, pressure, and time ranges are readily apparent from this disclosure.

Any suitable vessel or container can be used for step (a), so long as the vessel or container is capable of contacting (e.g., submerging) the pre-cursor membrane in the aqueous mixture (or solution), e.g., for a time period sufficient for the aqueous mixture (or solution) to diffuse and/or wick into the pores of the pre-cursor membrane. Step (a) can be performed batchwise or continuously. Moreover, during step (a), the aqueous mixture (or solution) can be subjected to agitation to improve the uniformity of the reactive components (or any polymer that may have been formed) within the aqueous mixture (or solution) during pore diffusion.

Prior to step (a), the pre-cursor membrane can be dry in one aspect of this invention, while in another aspect, the pre-cursor membrane can be wet prior to step (a), and in yet another aspect, the pre-cursor membrane can be dry prior to step (a) but additionally wetted in water prior to step (a).

After step (a) has been performed—the pre-cursor membrane has been sufficiently contacted with the aqueous mixture or solution—but before step (b), the pre-cursor membrane can be partially dried. In particular, prior to step (b), excess water or excess aqueous mixture/solution can be removed from the pre-cursor membrane. The pre-cursor is only partially dried, such that a suitable amount of water (and sodium styrene sulfonate monomer, initiator, and crosslinker) remain in the pores.

Referring now to step (b), the pre-cursor membrane is cured to form the ultrafiltration membrane, and the ultrafiltration membrane therefore contains sulfonated polystyrene covalently bound in pores and/or covalently bound on an external surface of the ultrafiltration membrane (i.e., covalently bound in the pores, or covalently bound on the external surface, or covalently bound both in the pores and on the external surface). Sulfonated polystyrene is used herein to encompass substituted styrenic moieties, e.g., methylated polystyrene groups.

Any suitable curing method can be utilized in step (b), such as subjecting the pre-cursor membrane to UV radiation (UV photoinitiation) or to electron beam radiation. However, it was determined herein that the pre-cursor membrane can be conveniently cured with heat. Hence, in one aspect of this invention, curing in step (b) can comprise subjecting the pre-cursor membrane to an elevated temperature, which typically falls within a range from 70 to 200° C., although not limited thereto. Other suitable temperature ranges include from 70 to 150° C., from 95 to 180° C., or from 80 to 130° C. In these and other aspects, these temperature ranges also are meant to encompass circumstances where the thermal curing is performed at a series of different temperatures, instead of at a single fixed temperature, wherein at least one temperature falls within the respective ranges. The maximum cure temperature often can depend upon the melting or softening point of the polyethersulfone (PES) and/or the polysulfone (PSF) used for the pre-cursor membrane as well as that of any support layer (e.g., which may be PP-based or PET-based). Illustrative and non-limiting cure times include a wide range of time periods, such as from 1 min to 24 hr, from 1 min to 1 hr, from 5 min to 6 hr, from 15 min to 5 hr, or from 30 min to 2 hr, but is not limited solely to these time periods. Other appropriate temperature and time ranges are readily apparent from this disclosure. The curing process can be performed batchwise or continuously.

In one aspect, after step (b), the ultrafiltration membrane can be rinsed with water, and this can occur in the same location as that of step (b) or in a separate location. In another aspect, the ultrafiltration membrane after step (b) can rinsed with water, contacted with an aqueous glycerin solution, and then dried.

Consistent with aspects of this invention, the pre-cursor membrane and the ultrafiltration membrane can further contain a mechanical support layer positioned underneath (and attached to) the respective membrane. This additional layer generally is present before step (a). The mechanical support layer can be constructed of any suitable material, but often is PP-based or PET-based, such as a non-woven PP or a non-woven PET. As above, depending upon the composition of the mechanical support layer and its melting or softening temperature, the curing temperature in step (b) may be varied. For a broader pH range during use of the membrane, PP often can be used as the support layer.

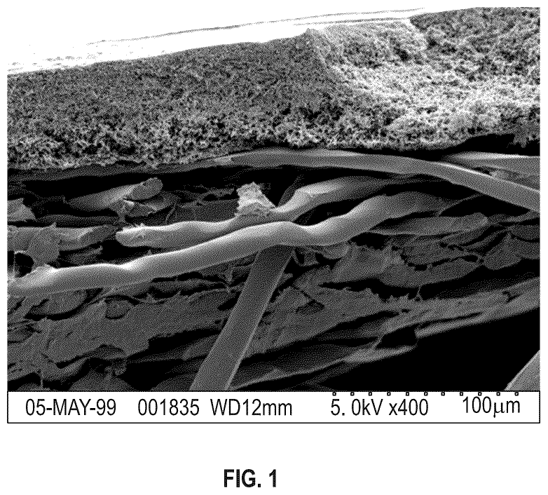

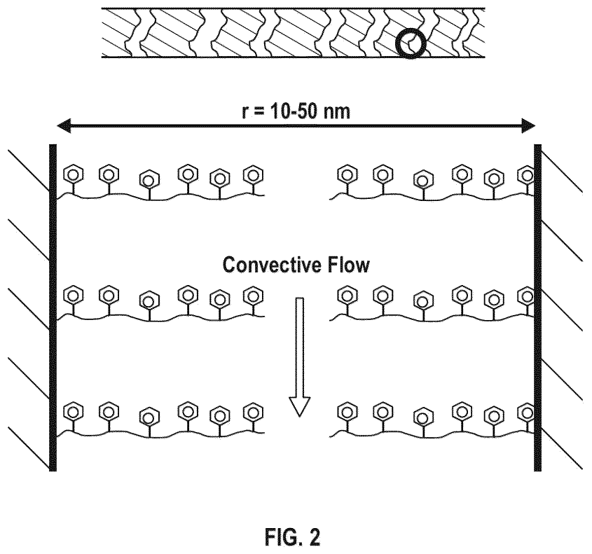

Also encompassed herein are ultrafiltration membranes that can comprise (I) a polyethersulfone (PES) and/or a polysulfone (PSF) membrane, and (II) sulfonated polystyrene covalently bound in pores and/or covalently bound on an external surface of the ultrafiltration membrane (i.e., covalently bound in the pores, or covalently bound on the external surface, or covalently bound both in the pores and on the external surface). These ultrafiltration membranes can be produced in accordance with any of the methods and processes described herein. Further, the ultrafiltration membrane can contain, and often does contain, a mechanical support layer positioned underneath (and attached to) the membrane. As above, suitable PP or PET non-woven materials typically are used as the mechanical support layer. A photograph of a representative pre-cursor membrane is shown in FIG. 1, with a top layer of PES or PSF and a bottom mechanical support layer of PP or PET. Generally, the layers are interconnected such that the 2-layer configuration does not delaminate. FIG. 2 illustrates covalently bonded polystyrene in the pores of the ultrafiltration membrane (the sulfonic acid or sulfonate groups are not shown explicitly, only the polystyrene grafts).

In an aspect, the disclosed ultrafiltration membranes can be characterized by a water permeability (or a skim milk permeability) that is at least 10% greater, and in some instances, at least 15% greater, at least 20% greater, at least 30% greater, at least 50% greater, at least 100% greater, or at least 200% greater, than that of a 10 kDa molecular weight cutoff (MWCO) membrane. Additionally or alternatively, the ultrafiltration membranes disclosed herein can be characterized by a water permeability of at least 120 L/m²-hr-bar, such as at least 140, at least 160, at least 180, at least 200, at least 250, or at least 500 L/m²-hr-bar. These are minimum threshold values, since generally the maximum value is not determined, so long as the minimum threshold value is exceeded. Water permeability testing and skim milk permeability testing is further described in the examples that follow.

In an aspect, the disclosed ultrafiltration membranes can be characterized by a percent rejection of protein that is greater than or equal to that for a 10 kDa MWCO membrane. Additionally or alternatively, the disclosed ultrafiltration membranes can be characterized by a percent rejection of protein that is greater than or equal to that for membrane. Additionally or alternatively, the ultrafiltration a 20 kDa MWCO membranes disclosed herein can be characterized by a percent rejection of protein in skim milk of at least 90%, and in some instances, at least 92%, at least 95%, or at least 97%. Protein rejection testing is further described in the examples that follow.

To determine if sulfonated polystyrene grafts are not covalently bound in the pores of the membrane, the membrane can be subjected to the clean-in-place (CIP) cleaning procedure described in the example section below, followed by an analysis of the membrane using ATR-FTIR at a wavenumber of 1036 cm⁻¹. After the CIP cleaning procedure, sulfonated polystyrene moieties that are not covalently bound will be removed. In these circumstances, there will be no significant peak at the wavenumber of 1036 cm⁻¹.

In contrast, the disclosed ultrafiltration membranes (with covalent attached sulfonated polystyrene) have a significant peak using ATR-FTIR at a wavenumber of 1036 cm⁻¹. Herein, the (charged) ultrafiltration membrane is considered to have covalently bound sulfonated polystyrene if the integrated absorbance area under an ATR-FTIR curve at a wavenumber of 1036 cm⁻¹ is greater than or equal to 0.05, after the CIP cleaning procedure. In some aspects, after the CIP cleaning procedure, the ultrafiltration membranes described herein can be characterized by an integrated absorbance area under an ATR-FTIR curve at a wavenumber of 1036 cm⁻¹ of greater than or equal to 0.08; alternatively, greater than or equal to 0.1; alternatively, greater than or equal to 0.2; alternatively, greater than or equal to 0.3; alternatively, greater than or equal to 0.5; or alternatively, greater than or equal to 0.7. These integrated absorbance areas are minimum threshold values, since generally the maximum value is not determined, so long as the minimum threshold value is exceeded.

In an aspect, the disclosed ultrafiltration membranes can be capable of being cleaned-in-place (CIP) using the CIP cleaning procedure described in the examples below. Due to covalent bonding, the charged membranes described herein generally are stable during CIP procedures. Cleaning may be needed when the flux through the membrane decreases to a particular level, such as a flux reduction in excess of 5-10% of the initial flux. The membrane can then be subjected to the CIP cleaning procedure prior to being placed back into service.

In an aspect, the disclosed ultrafiltration membranes can have a lifetime of at least 1 month, at least 3 months, at least 6 months, or at least 1 year. Due to the covalently bound sulfonated polystyrene moieties in the pores of the UF membrane, it is believed that membrane lifetime will be improved over similarly modified membranes in which covalent bonding is not achieved.

Systems and Processes that Utilize Ultrafiltration Membranes

The disclosed UF membranes, which contain sulfonated polystyrene covalently bound in pores and/or covalently bound on an exterior surface of the UF membrane, can be utilized in various apparatus, systems, and processes. One such apparatus is an ultrafiltration module that can comprise (1) an inlet for a feed stream, (2) one or more of any of the ultrafiltration membranes disclosed herein in any suitable configuration, such as a hollow fiber configuration, a tubular configuration, or a spiral wound configuration, (3) a first outlet for a UF retentate stream, and (4) a second outlet for a UF permeate stream. The feed stream that enters the ultrafiltration module through the inlet can be any suitable dairy product, such as whole milk or skim milk, although not limited thereto. Generally, the ultrafiltration module employs a plurality of ultrafiltration membranes, for instance, in a spiral wound configuration.

A representative milk fractionation system can comprise (A) one or more than one of any of the ultrafiltration modules disclosed herein, (B) a nanofiltration module, and (C) a reverse osmosis module. Other milk fractionation systems encompassed herein can comprise one or more than one of any of the ultrafiltration modules disclosed herein, a nanofiltration module, and a forward osmosis module; alternatively, one or more than one of any of the ultrafiltration modules disclosed herein and a nanofiltration module; alternatively, one or more than one of any of the ultrafiltration modules disclosed herein and a reverse osmosis module; or alternatively, one or more than one of any of the ultrafiltration modules disclosed herein and a forward osmosis module. Typically, the milk fractionation system employs a plurality of ultrafiltration modules.

Also provided herein are methods for making a dairy composition in which an ultrafiltration membrane is employed. An illustrative method can comprise (i) ultrafiltering a milk product using any of the ultrafiltration membranes disclosed herein (or any of the ultrafiltration modules disclosed herein) to produce a UF permeate fraction and a UF retentate fraction, (ii) nanofiltering the UF permeate fraction to produce a NF permeate fraction and a NF retentate fraction, (iii) subjecting the NF permeate fraction to a reverse osmosis step to produce a RO permeate fraction and a RO retentate fraction, and (iv) combining at least two of the UF retentate fraction, the RO permeate fraction, the RO retentate fraction, and a fat-rich fraction to form the dairy composition. For instance, the dairy composition can contain at least the UF retentate fraction and the RO retentate fraction in one aspect, and the dairy composition can contain at least the UF retentate fraction, the RO retentate fraction, and the fat-rich fraction (cream) in another aspect.

### EXAMPLES

The invention is further illustrated by the following examples, which are not to be construed in any way as imposing limitations to the scope of this invention. Various other aspects, modifications, and equivalents thereof which, after reading the description herein, can suggest themselves to one of ordinary skill in the art without departing from the spirit of the present invention or the scope of the appended claims.

For Example 1, a first 100 mL solution was prepared by mixing the following components in a beaker at room temperature: 50 mL of deionized (DI) water, 1 mL of divinylbenzene (DVB), 20 mL of n-butanol, 20 mL of methanol, 12 g of sodium styrene sulfonate, and 0.4 g of potassium persulfate (K₂S₂O₈). The total weight of this first 100 mL solution was 95.31 g and the approximate amounts of each component—on a weight basis—were 52.5 wt. % DI water, 0.95 wt. % DVB, 16.8 wt. % n-butanol, 16.8 wt. % methanol, 12.6 wt. % sodium styrene sulfonate, and 0.42 wt. % potassium persulfate (K₂S₂O₈).

Once this first solution was homogeneous, it was diluted with a 2:1:1:1.7 solution of water:methanol:butanol:glycerin to double the volume to 200 mL total, and stirred for 5 min to ensure homogeneity. The total weight of this diluted 200 mL solution was 196.31 g and the approximate amounts of each component—on a weight basis—were 43.3 wt. % DI water, 0.47 wt. % DVB, 15.3 wt. % n-butanol, 15.3 wt. % methanol, 6.1 wt. % sodium styrene sulfonate, 0.2 wt. % potassium persulfate (K₂S₂O₈), and 19.4 wt. % glycerin.

Dry pre-cursor PE20 membranes having a 20 kDa MWCO were obtained from Solecta, Inc. These membranes were a polyethersulfone (PES) on a polypropylene (PP) backing. Two 5.5 in×7.5 in samples of the pre-cursor PE20 membrane were cut from the same vertical region of the membrane.

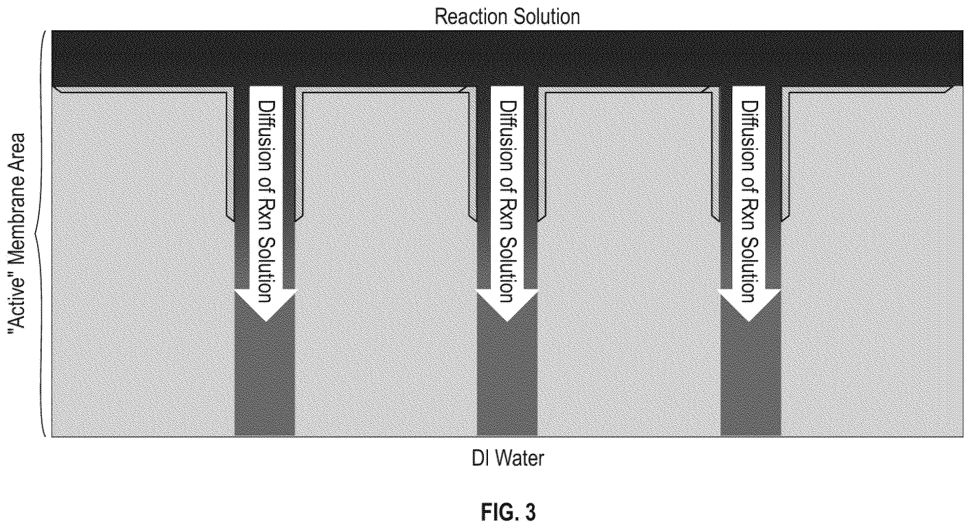

A first membrane sample (Example 1A) was submerged and soaked for 2 hr in the diluted 200 mL solution at room temperature while the solution was stirred continuously. While not wishing to be bound by theory, it is believed that no polymer or no significant amount of polymer is formed prior to the curing step. A representative schematic diagram of diffusion of the aqueous reaction solution into the pores of the pre-cursor membrane is illustrated in FIG. 3. Diffusion is one mechanism for getting the monomer into the pores, while another mechanism is to wick the aqueous reaction solution into open, dry pores. The dry pores also may be partially filled with glycerin from the drying process. The first membrane sample was removed from the solution and excess solution was drained off the membrane.

The second membrane sample (Example 1B) was quickly dipped in the diluted 200 mL solution for a time period of a few sec up to 10-30 sec, after which it was removed from the solution and excess solution was drained off the membrane. Both membrane samples were placed on a glass plate with the PP backing facing the glass and the edges clipped to prevent curling, but with a polypropylene mesh material in between to avoid direct contact with the glass and to allow evaporation from the backside of the membrane. The glass plate and the secured membrane was then inverted and placed in an oven (the PP backing was facing up and the PES was facing down towards the bottom of the oven) at 100° C. and thermally-cured for 1 hr. The cured membrane samples were removed from the oven and cooled at ambient temperature for 5 min before proceeding with any cleaning and/or testing of the membrane.

For Example 2, a first solution was prepared by mixing the following components in a beaker at room temperature: 25 mL of deionized (DI) water, 1.5 mL of divinylbenzene (DVB), 10 mL of n-butanol, 10 mL of methanol, 18 g of sodium styrene sulfonate, and 0.6 g of potassium persulfate (K₂S₂O₈). Once this first solution was homogeneous, it was diluted with 50 mL of a 2:1:1:1.7 solution of water:methanol:butanol:glycerin, and stirred for 5 min to ensure homogeneity. Thus, the diluted solution of Example 2 contained approximately 2.5× the concentration of DVB, sodium styrene sulfonate, and potassium persulfate (K₂S₂O₈) of Example 1. The approximate amounts of each component—on a weight basis—were 38.1 wt. % DI water, 1.2 wt. % DVB, 13.5 wt. % n-butanol, 13.5 wt. % methanol, 16.1 wt. % sodium styrene sulfonate, 0.5 wt. % potassium persulfate (K₂S₂O₈), and 17 wt. % glycerin. Submerged/soaked (Example 2A) and dipped (Example 2B) membrane samples were prepared from the diluted solution of Example 2 in the same manner as in Example 1. For Example 3, a first solution was prepared by mixing the following components in a beaker at room temperature: 25 mL of deionized (DI) water, 3 mL of divinylbenzene (DVB), 10 mL of n-butanol, 10 mL of methanol, 36 g of sodium styrene sulfonate, and 1.2 g of potassium persulfate (K₂S₂O₈). Once this first solution was homogeneous, it was diluted with 50 mL of a 2:1:1:1.7 solution of water:methanol:butanol:glycerin, and stirred for 5 min to ensure homogeneity. The diluted solution was not homogenous, so 10 mL of DI water was added and stirred for 10 min. The diluted solution of Example 3 contained approximately 4×-4.5× the concentration of DVB, sodium styrene sulfonate, and potassium persulfate (K₂S₂O₈) of Example 1. The approximate amounts of each component—on a weight basis—were 37.1 wt. % DI water, 1.9 wt. % DVB, 10.6 wt. % n-butanol, 10.6 wt. % methanol, 25.5 wt. % sodium styrene sulfonate, 0.9 wt. % potassium persulfate (K₂S₂O₈), and 13.4 wt. % glycerin. Submerged/soaked (Example 3A) and dipped (Example 3B) membrane samples were prepared from the diluted solution of Example 3 in the same manner as in Example 1.

For Example 4, a first solution was prepared by mixing the following components in a beaker at room temperature: 25 mL of deionized (DI) water, 3 mL of divinylbenzene (DVB), 10 mL of n-butanol, 10 mL of methanol, 18 g of sodium styrene sulfonate, and 1.2 g of potassium persulfate (K₂S₂O₈). Once this first solution was homogeneous, it was diluted with 50 mL of a 2:1:1:1.7 solution of water:methanol:butanol:glycerin, and stirred for 5 min to ensure homogeneity. In this case, the diluted solution was not homogeneous, so 10 mL of n-butanol was added and stirred for 10 min. The diluted solution of Example 4 contained approximately 5× the concentration of DVB and potassium persulfate (K₂S₂O₈) and 2.5× the concentration of sodium styrene sulfonate of Example 1. The approximate amounts of each component—on a weight basis—were 35 wt. % DI water, 2.3 wt. % DVB, 18.9 wt. % n-butanol, 12.4 wt. % methanol, 14.8 wt. % sodium styrene sulfonate, 1 wt. % potassium persulfate (K₂S₂O₈), and 15.6 wt. % glycerin. Submerged/soaked (Example 4A) and dipped (Example 4B) membrane samples were prepared from the diluted solution of Example 4 in the same manner as in Example 1.

Comparative Example 5 was a PE10 membrane having a 10 kDa MWCO obtained from Solecta, Inc. (PES on a PET backing). Comparative Example 6 was a PE20 membrane having a 20 kDa MWCO obtained from Solecta, Inc. (PES on a PP backing), before any modification as described in Examples 1-4.

### Flux, Permeability, and Protein Rejection Experiments

Pure water permeability was measured on a dead end cell with a stainless-steel membrane holder. Water permeability was measured following a 2-min spike at 90 psig. Skim milk permeability and process flux and protein rejection testing were performed similarly using the same dead end cell with stainless-steel membrane holder following a 2-min spike at 25 psig.

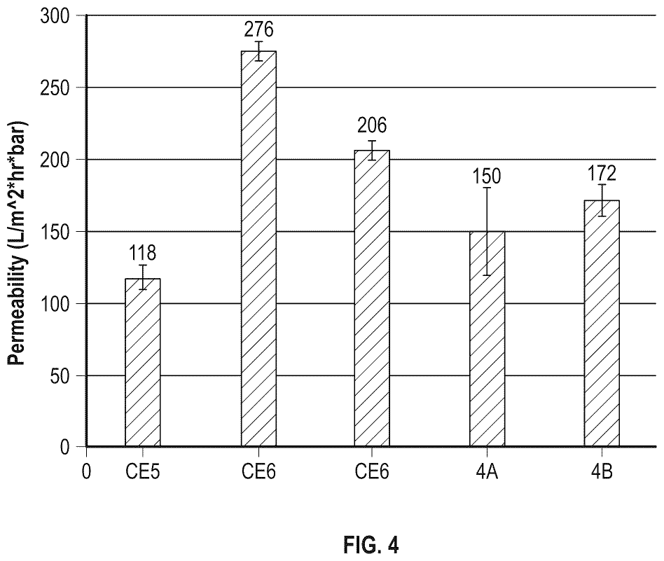

FIG. 4 summarizes the results of water permeability testing on the pre-cursor membranes of Comparative Examples 5-6 and the charged ultrafiltration membranes of Examples 4A-4B. Flux was measured using a stainless-steel dead-end cell fed from a stainless-steel tank pressurized with compressed air. The feed pressure was initially spiked to 90 psig for 2 min to ensure full wetting of the membranes. Flux data was collected by measuring 5 pressures at a 5 psig difference, measured over 60 sec, and each pressure measurement was triplicated. The permeabilities of the pre-cursor membrane of Comparative Example 5 (PE10) and the charged ultrafiltration membranes of Examples 4A-4B are shown as single bars in FIG. 4, while two different samples of Comparative Examples 6 (PE20) were tested. The PE20 membranes of Comparative Example 6 had much higher pure water permeability (before reaction/impregnation) than the PE10 membrane of Comparative Example 5. Examples 4A-4B in FIG. 4 demonstrate the impact of the sulfonated polystyrene bound in the pores on the pore size of the membrane, and therefore the reduction in water permeability over the pre-cursor PE20 membrane. Unexpectedly, and beneficially, the charged ultrafiltration membranes of Examples 4A-4B after reaction/impregnation had significantly higher water permeability than that of the PE10 membrane of Comparative Example 5, and had surprisingly high water permeability values of at least 150 L/m²-hr-bar.

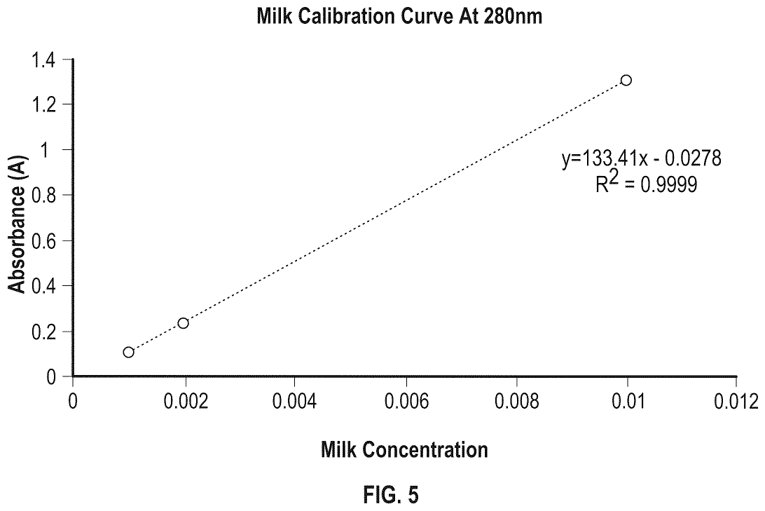

Testing of various membranes with skim milk was then undertaken. FIG. 5 is a milk calibration curve, which plots absorbance versus milk concentration at a wavelength of 280 nm. The technique is based on absorbance of amino acids that are part of the milk proteins. The calibration curve was constructed using three known concentrations of skim milk in solution (e.g., dilution factors of 200 to 1000) with absorbances around or below 1. From this calibration curve and the regression equation, the protein concentration of permeates was determined from the absorbance reading of the permeate.

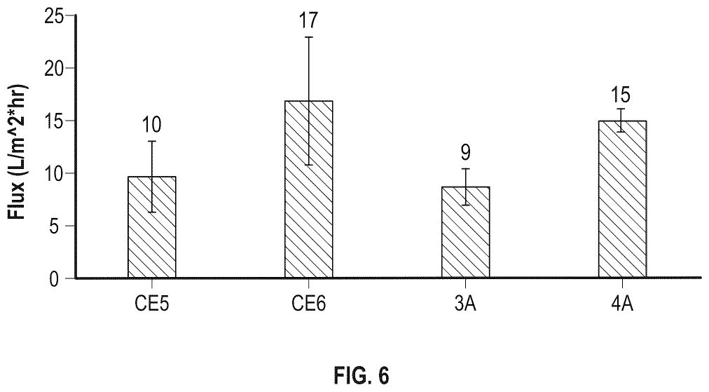

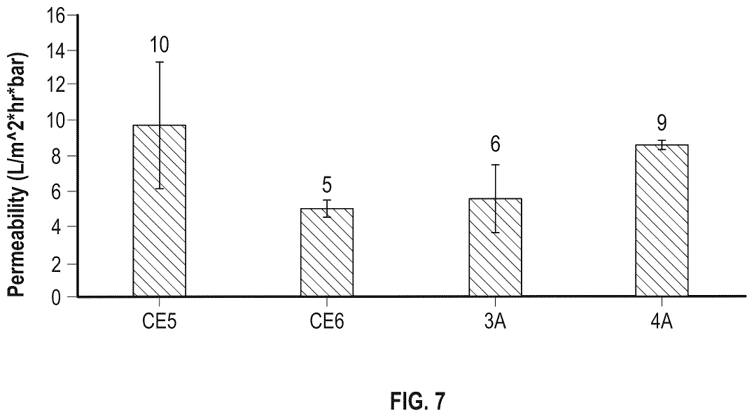

FIGS. 6-7 summarize the results of skim milk process flux and skim milk permeability testing on the pre-cursor membranes of Comparative Examples 5-6 and the charged ultrafiltration membranes of Examples 3A and 4A. Flux and permeability were measured as described above for water testing, but skim milk was used instead at 25 psig. The skim milk contained nominally 91 wt. % water, 0.75 wt. % minerals, 5 wt. % carbohydrates/lactose, 3.3 wt. % protein, and 0.1 wt. % fat. Similar to FIG. 4, the skim milk process flux and skim milk permeability for the charged ultrafiltration membranes of Examples 3A and 4A generally fell between that of the PE20 membrane of Comparative Example 6 and the PE10 membrane of Comparative Example 5, as shown in FIGS. 6-7. It is believed that the large error bars were the result of insufficient sample collection times and differences in flow between two different flow cells due to stir plates.

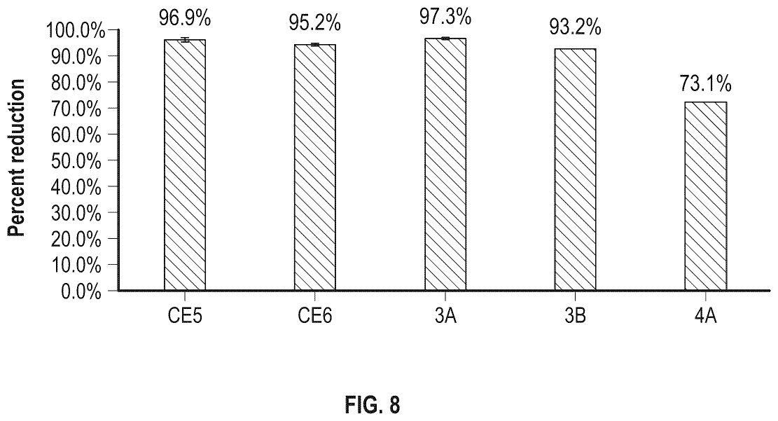

FIG. 8 summarizes the protein rejection for the pre-cursor membranes of Comparative Examples 5-6 and the charged ultrafiltration membranes of Examples 3A-3B and 4A. Protein rejection (%) was determined for the various membranes using skim milk in a dead end cell with stainless-steel membrane holder loaded with ~25 mL of skim milk, with the stirrer set on 3, and with an applied pressure of 25 psig. Protein concentrations was determined by UV-visible spectrophotometry at 280 nm and the calibration curve in FIG. 5, and the percent reduction was determined by calculating milk concentration in the permeate and comparing that to the 100% skim milk feed. With the exception of Example 4A, the protein rejection was about 95% for each of the other membranes.

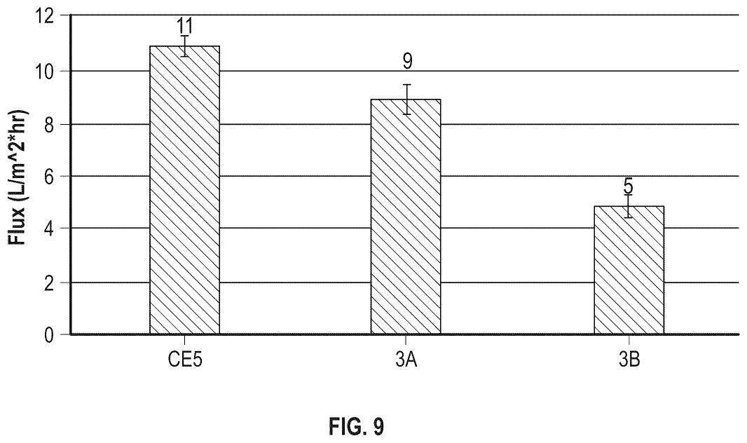

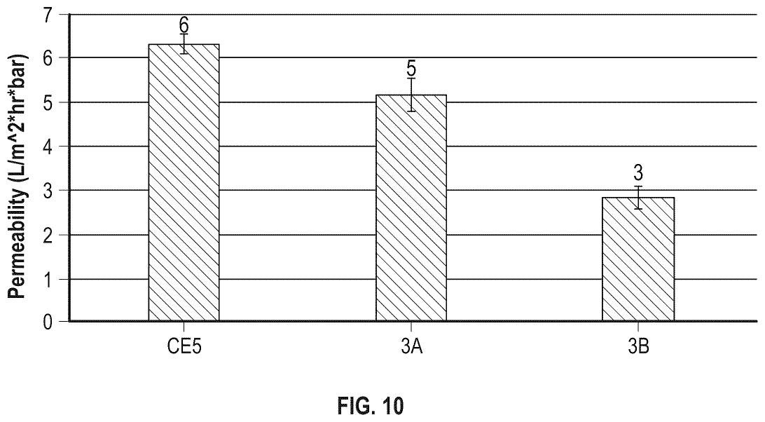

FIGS. 9-11 are similar to FIGS. 6-8 but the testing was performed with new stir plates to improve consistency and to reduce the error bars. The charged ultrafiltration membrane of Example 3A (submerged/soaked) had slightly lower process flux and permeability than the pre-cursor membrane of Comparative Example 5, while the charged ultrafiltration membrane of Example 3B (dipped) did not perform as well, as shown in FIGS. 9-10. While not wishing to be bound by theory, it is believed that the (dipped) membrane of Example 3B did not perform as well as the (submerged/soaked) membrane of Example 3A, due to the lower amount of time allowed for the impregnation solution to fully diffuse and wet the pores, thus some plugging of the pores may have occurred.

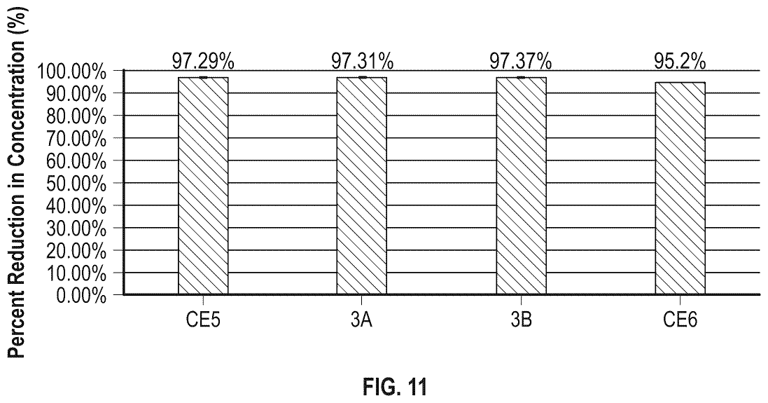

Referring to FIG. 11, the protein rejection (97.3%) of the charged ultrafiltration membranes of Examples 3A-3B were unexpectedly the same as that of the pre-cursor membrane of Comparative Example 5 and superior to that of Comparative Example 6. Given the excellent protein rejection performance of the charged ultrafiltration membranes of Examples 3A-3B, the monomer/reactant concentration can be increased or decreased to increase the flux or permeability, for example, to be equivalent or better than that of the PE10 membrane of Comparative Example 5.

### Covalent Bonding Experiments

For these experiments, the charged ultrafiltration membrane of Example 2A (submerged/soaked) and the pre-cursor PE20 membrane of Comparative Example 6 were soaked in water overnight to remove glycerin.

Example 7 was prepared similarly to that of Example 3A from a pre-cursor PE20 membrane. Submerged/soaked Example 7 membrane samples were prepared from the impregnation solution of Example 7 in the same manner as in Example 1. Thereafter, the charged ultrafiltration membrane of Example 7 was soaked in water overnight to remove glycerin.

For Example 8, an aqueous reaction solution was prepared in a round bottom flask by combining 50 mL of DI water, 1 mL of divinylbenzene (DVB), 20 mL of n-butanol, 20 mL of methanol, 12 g of sodium styrene sulfonate, and 0.4 g of potassium persulfate (K₂S₂O₈). This reaction solution was heated under reflux for 75 min, then cooled/quenched with a 2:1:1:1.7 solution of water:methanol:butanol:glycerin to reach a total volume of 200 mL and stirring for 1 hr. Then, 0.8 mL of divinylbenzene (DVB) and 0.8 g of potassium persulfate (K₂S₂O₈) were added and stirred at room temperature until homogeneous. Submerged/soaked Example 8 membrane samples were prepared from this mixture (over a 2 hr time interval) in the same manner as in Example 1 at room temperature, but no subsequent curing step was used. Thereafter, the charged ultrafiltration membrane of Example 8 was soaked in water overnight to remove glycerin.

The pre-cursor membrane of Comparative Example 6 and the ultrafiltration membranes of Examples 2A and 7-8 were then analyzed using ATR-FTIR both before and after the following rigorous clean-in-place (CIP) cleaning procedure, which was performed in a dead-end cell at a pressure in the 20-30 psig range. The order of operations for the CIP cleaning procedure was:
1) 1 hr Caustic Solution
2) 5 min DI Water
3) 30 min HCl in DI water (pH 3)
4) 5 min DI Water
5) 30 min Caustic Solution
6) 5 min DI Water

The caustic solution consisted of 1000 mL of DI water, 0.8 mL of Apollo 8 surfactant, 0.25 mL of bleach, and NaOH to reach a pH equal to 10. The purpose of the CIP cleaning procedure was to remove any chemistry from the membrane surfaces/pores that is not covalently bound. Simple washing or rinsing the modified membranes with water is not sufficient to remove the sulfonated polystyrene moieties from the surfaces/pores of the membrane.

ATR-FTIR was performed with a Perkin Elmer Spectrum Two FT-IR Spectrometer with ATR with 8 scans, a 4 cm⁻¹ resolution, over the full range of 400-4000 cm⁻¹, with the wavenumber of 1036 cm⁻¹ selected as a key wavenumber for the absorbance of sulfonated polystyrene moieties. Five samples across different locations of the respective membrane surface for each example were tested (and then averaged). The dried membrane surface was placed face down on the top of the light crystal of the ATR-FTIR instrument.

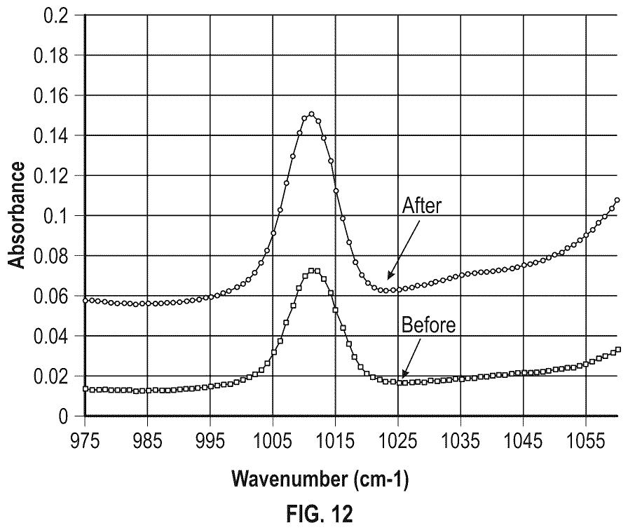

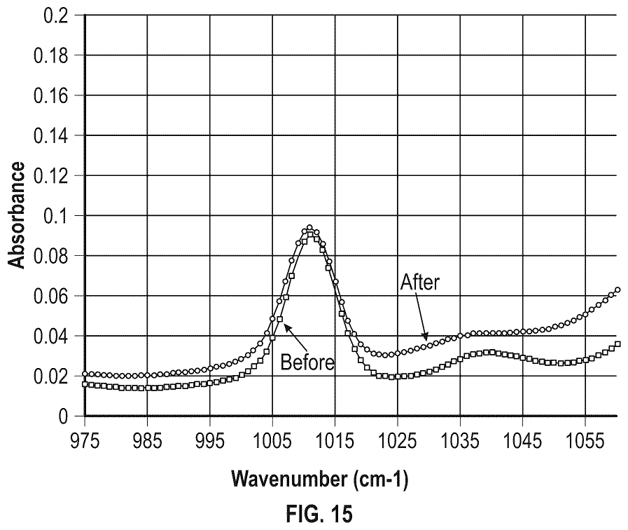

FIGS. 12-15 are plots of absorbance versus wavenumber (cm⁻¹) for, respectively, the pre-cursor membrane of Comparative Example 6, the ultrafiltration membrane of Example 2A, the ultrafiltration membrane of Example 7, and the ultrafiltration membrane of Example 8, both before and after the CIP cleaning procedure. Referring first to FIG. 12, at the wavenumber of 1036 cm⁻¹, there are no peaks observed either before or after the CIP cleaning procedure for Comparative Example 6, and this was expected since no polymer was grafted/applied to the PE20 membrane surfaces/pores. Referring now to FIG. 15, at the wavenumber of 1036 cm⁻¹, there was a small peak observed before the CIP cleaning procedure for Example 8, but after the CIP cleaning procedure, no peak was observed (i.e., no polymer was covalently bound to the membrane surfaces/pores).

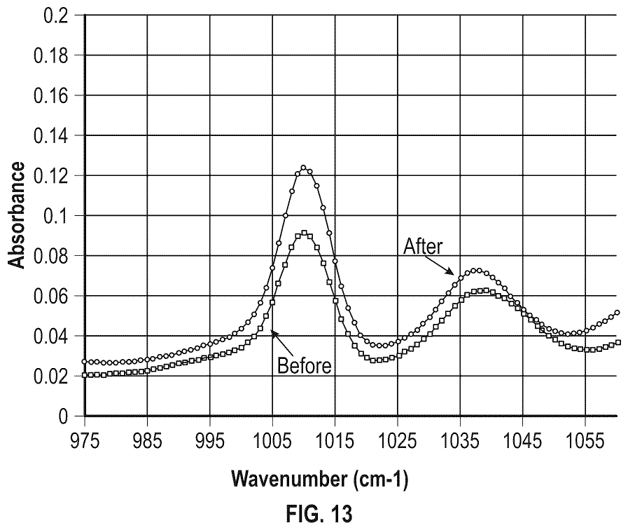

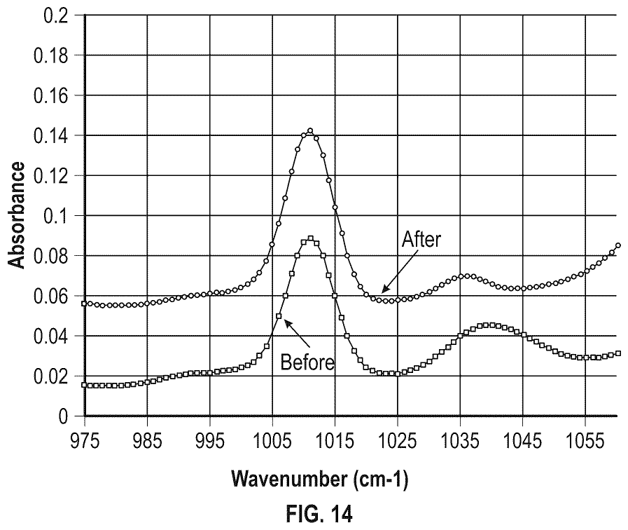

In FIG. 13, significant peaks at the wavenumber of 1036 cm⁻¹ are observed both before and, more importantly, after the CIP cleaning procedure for Example 2A. Thus, sulfonated polystyrene was covalently bound to the membrane surfaces/pores in Example 2A. In FIG. 14, a significant peak at the wavenumber of 1036 cm⁻¹ was observed before and a smaller peak was observed after the CIP cleaning procedure for Example 7. Thus, there was sulfonated polystyrene covalently bound to the membrane surfaces/pores in Example 7, but excess monomer likely was removed during the CIP cleaning procedure.

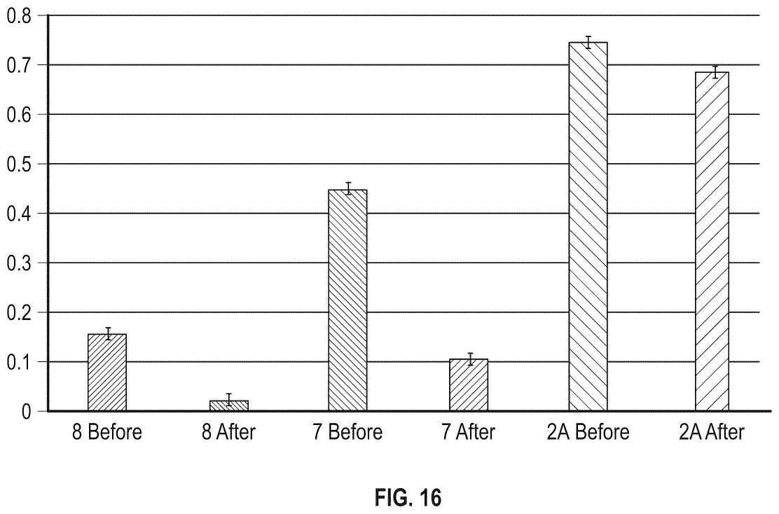

FIG. 16 is a quantitative analysis of the respective integrated area under the ATR-FTIR curves of FIGS. 13-15 for the ultrafiltration membranes of Examples 2A and 7-8 before and after the CIP cleaning procedure. The errors bars shown are the integrated area for the curve of the PE20 Comparative Example 6 shown in FIG. 12, and is considered to be instrumentation and testing variability. The integrated area is the area under the peak at 1036 cm⁻¹ and above a line drawn from the valley/minima at a wavenumber below 1036 cm⁻¹ to the valley/minima above the wavenumber of 1036 cm⁻¹. After the CIP cleaning procedure, the integrated area for Example 8 was about 0.025 (likely due to instrumentation and testing variability), whereas the integrated areas for Example 7 and Example 2A were unexpectedly 0.11 and 0.68, respectively.

These examples demonstrate that the CIP cleaning procedure removes the peak at the wavenumber of 1036 cm⁻¹ for non-covalently bound sulfonated polystyrene moieties, such as in Example 8. Membranes with covalently bound sulfonated polystyrene retain the peak at the wavenumber of 1036 cm⁻¹ even after the rigorous CIP cleaning procedure, as evidenced by Examples 2A and 7.

1. A method of making an ultrafiltration membrane, the method comprising:
(a) contacting a pre-cursor membrane comprising a polyethersulfone (PES) and/or a polysulfone (PSF) with an aqueous mixture comprising sodium styrene sulfonate, a free radical initiator, a crosslinking agent, and water; and
(b) curing the pre-cursor membrane to form the ultrafiltration membrane, wherein the ultrafiltration membrane has sulfonated polystyrene covalently bound in pores and/or covalently bound on an external surface of the ultrafiltration membrane.

2. The method of claim 1, wherein:
the pre-cursor membrane is dry prior to step (a); or
the pre-cursor membrane is wet prior to step (a); or
the pre-cursor membrane is dry prior to step (a), and is wetted in water prior to step (a).

3. The method of claim 1, wherein the aqueous mixture comprises from 1 to 60 wt. %, from 2 to 45 wt. %, from 3 to 25 wt. %, from 5 to 25 wt. %, from 7 to 23 wt. %, or from 10 to 30 wt. % sodium styrene sulfonate.

4. The method of claim 1, wherein the aqueous mixture comprises from 0.1 to 5 wt. %, from 0.1 to 1.5 wt. %, from 0.2 to 3 wt. %, from 0.2 to 1.5 wt. %, or from 0.2 to 1 wt. % of the free radical initiator.

5. The method of claim 1, wherein the free radical initiator comprises potassium persulfate, sodium persulfate, ammonium persulfate, azobisisobutyronitrile (AIBN), or any combination thereof.

6. The method of claim 1, wherein the aqueous mixture comprises from 0.1 to 8 wt. %, from 0.2 to 6 wt. %, from 0.3 to 4 wt. %, from 0.4 to 3 wt. %, or from 0.5 to 2 wt. % of the crosslinking agent.

7. The method of claim 1, wherein the crosslinking agent comprises divinyl acetylene, divinyl sulfone, 5-hexadiene, divinylbenzene, a substituted divinylbenzene, or any combination thereof.

8. The method of claim 1, wherein the aqueous mixture comprises a co-solvent.

9. The method of claim 8, wherein the co-solvent comprises methanol, n-butanol, or a combination thereof.

10. (canceled)

11. The method of claim 1, wherein the aqueous mixture further comprises from 0.1 to 25 wt. %, from 0.5 to 20 wt. %, from 1 to 15 wt. %, from 2 to 8 wt. %, from 5 to 25 wt. %, or from 10 to 20 wt. % of a pore wetting agent, such as glycerin.

12. The method of claim 1, wherein the aqueous mixture comprises from 20 to 80 wt. %, from 30 to 70 wt. %, from 30 to 45 wt. %, from 35 to 50 wt. %, or from 40 to 65 wt. % water.

13. The method of claim 1, wherein step (a) is performed for a time sufficient for the aqueous mixture to diffuse and/or wick into the pores of the pre-cursor membrane.

14. (canceled)

15. The method of claim 1, wherein the aqueous mixture is a solution.

16. The method of claim 1, wherein the pre-cursor membrane is partially dried prior to step (b).

17. The method of claim 1, wherein curing in step (b) comprises:
subjecting the pre-cursor membrane to an elevated temperature in a range from 70 to 200° C.; or
subjecting the pre-cursor membrane to UV radiation or electron beam radiation.

18. The method of claim 1, wherein the ultrafiltration membrane after step (b) is:
rinsed with water; or
rinsed with water, contacted with an aqueous glycerin solution, and dried.

19. The method of claim 1, wherein the pre-cursor membrane and the ultrafiltration membrane comprise a mechanical support layer positioned underneath (and attached to) the respective membrane.

20. The ultrafiltration membrane prepared by the method of claim 1.

21. An ultrafiltration membrane comprising:
(I) a polyethersulfone (PES) and/or a polysulfone (PSF) membrane; and
(II) sulfonated polystyrene covalently bound in pores and/or covalent bound on an external surface of the ultrafiltration membrane.

22-26. (canceled)

27. The membrane of claim 21, wherein the ultrafiltration membrane, after a CIP cleaning procedure, is characterized by an integrated absorbance area under an ATR-FTIR curve at a wavenumber of 1036 cm⁻¹ of greater than or equal to 0.05, greater than or equal to 0.08, greater than or equal to 0.1, greater than or equal to 0.2, greater than or equal to 0.3, greater than or equal to 0.5, or greater than or equal to 0.7.

28-30. (canceled)
